(19) United States
(12) Patent Application Publication
(10) Pub. No.: US 2021/0131454 A1
(43) Pub. Date: May 6, 2021

(54) FLUID CIRCUIT OF AIR CYLINDER

(71) Applicant: SMC CORPORATION, Chiyoda-ku (JP)

(72) Inventors: Gohei HARIMOTO, Moriya-shi (JP); Mitsuru SENOO, Moriya-shi (JP); Yuto FUJIWARA, Tsukubamirai-shi (JP)

(73) Assignee: SMC CORPORATION, Chiyoda-ku (JP)

(21) Appl. No.: 17/251,093

(22) PCT Filed: Jun. 7, 2019
(86) PCT No.: PCT/JP2019/022678

§ 371 Date: Dec. 10, 2020

(30) Foreign Application Priority Data
Jun. 13, 2018 (JP) 2018-113156

(51) Int. Cl. F15B 11/06; F15B 11/024; F15B 11/044

(52) U.S. Cl. CPC F15B 11/06; F15B 11/044; F15B 11/024

(57) ABSTRACT

A first fluid circuit is a fluid circuit of an air cylinder provided with an air cylinder with a first air chamber and a second air chamber that are defined by a piston; a switching valve that is switched between the drive step and return step of the piston; a first flow channel between the first air chamber and the switching valve; and a second flow channel between the second air chamber and the switching valve. Two speed control valves are provided in series in the second flow channel.

### TECHNICAL FIELD

The present invention relates to fluid circuits of air cylinders.

### BACKGROUND ART

A fluid circuit described in Japanese Laid-Open Patent Publication No. 2018-054117 addresses problems in reducing the time required to return a fluid pressure cylinder as much as possible while saving energy by reusing discharge pressure to return the fluid pressure cylinder.

To solve the above-described problems, the fluid circuit described in Japanese Laid-Open Patent Publication No. 2018-054117 includes a switching valve, a fluid supply source, an exhaust port, and a check valve for supply. When the switching valve is in a first position, a first cylinder chamber communicates with the fluid supply source, and a second cylinder chamber communicates at least with the exhaust port. When the switching valve is in a second position, the first cylinder chamber communicates with the second cylinder chamber via the check valve for supply, and the first cylinder chamber communicates at least with the exhaust port.

### SUMMARY OF INVENTION

The fluid circuit described in Japanese Laid-Open Patent Publication No. 2018-054117 is provided with a throttle valve on the path to the exhaust port. Thus, only the discharge rate from an air cylinder can be adjusted, and the supply rate to the air cylinder cannot be adjusted.

The present invention has been devised taking into consideration the aforementioned circumstances, and has the object of providing a fluid circuit of an air cylinder enabling supply rate to the air cylinder and discharge rate from the air cylinder to be adjusted independently and yet having a structure that can be simplified.

A fluid circuit of an air cylinder according to an aspect of the present invention comprises an air cylinder including a first air chamber and a second air chamber partitioned by a piston, a switching valve configured to switch between a position for a drive process of the piston and a position for a return process of the piston, a first flow path disposed between the first air chamber and the switching valve, and a second flow path disposed between the second air chamber and the switching valve. Two speed control valves (each including an adjustable throttle valve and a check valve) are disposed in series on the second flow path.

In accordance with the fluid circuit of the air cylinder according to the present invention, the supply rate to the air cylinder and the discharge rate from the air cylinder can be adjusted independently, and yet the structure of the fluid circuit can be simplified.

### BRIEF DESCRIPTION OF DRAWINGS

FIG. 1A is a circuit diagram of a fluid circuit (first fluid circuit) of an air cylinder according to a first embodiment when a switching valve of the first fluid circuit is in a first state, and FIG. 1B illustrates a state of the first fluid circuit during a drive process;

FIG. 2A is a circuit diagram when the switching valve of the first fluid circuit is in a second state, and FIG. 2B illustrates a state of the first fluid circuit during a return process;

FIG. 3 is a perspective view of an example external appearance of the air cylinder;

FIG. 4 is a circuit diagram of a modification of the first fluid circuit;

FIG. 5A is a circuit diagram of a fluid circuit (second fluid circuit) of an air cylinder according to a second embodiment when a switching valve of the second fluid circuit is in a first state, and FIG. 5B illustrates a state of the second fluid circuit during a drive process;

FIG. 6A is a circuit diagram when the switching valve of the second fluid circuit is in a second state, and FIG. 6B illustrates a state of the second fluid circuit during a return process; and

FIG. 7 is a circuit diagram of a modification of the second fluid circuit.

### DESCRIPTION OF EMBODIMENTS

Preferred embodiments of a fluid circuit of an air cylinder according to the present invention will be described in detail below with reference to the accompanying drawings.

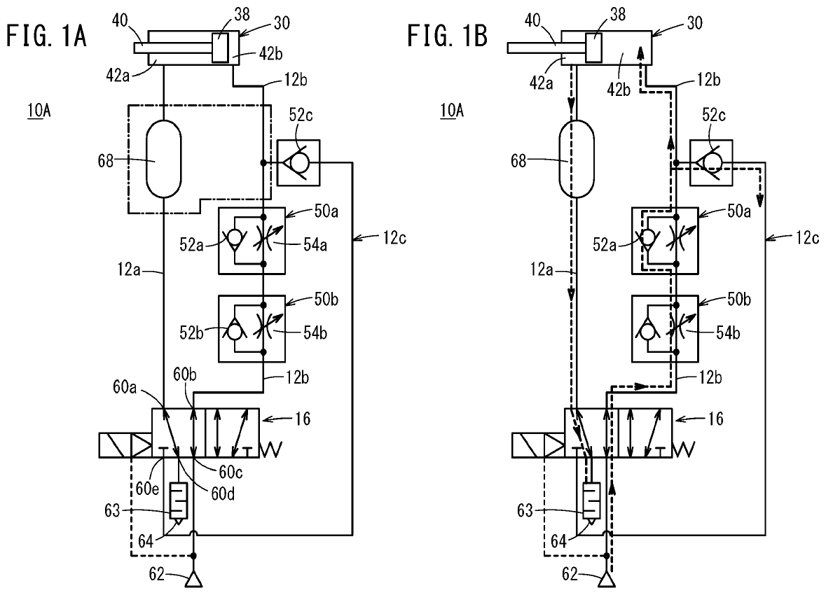

First, a fluid circuit of an air cylinder according to a first embodiment (hereinafter referred to as “first fluid circuit 10A”) will be described with reference to FIGS. 1A to 4.

As illustrated in FIG. 1A, the first fluid circuit 10A includes a first air path 12a, a second air path 12b, and a switching valve 16.

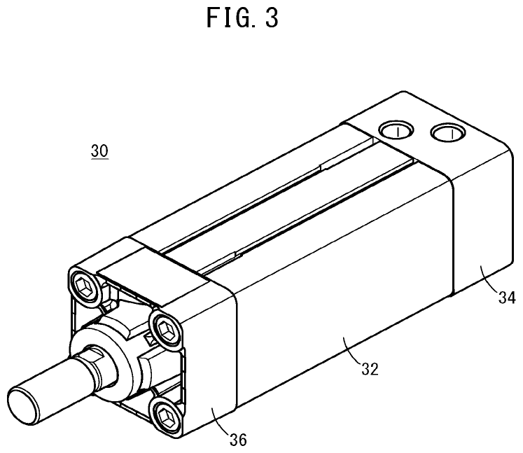

As illustrated in FIGS. 1A, 1B and 3, an air cylinder 30 includes a cylinder tube 32, a head cover 34, a rod cover 36, a piston 38 (see FIG. 1A), a piston rod 40, and other components. A first end of the cylinder tube 32 is closed by the rod cover 36, and a second end of the cylinder tube 32 is closed by the head cover 34. The piston 38 (see FIG. 1A) is disposed inside the cylinder tube 32 to be reciprocable. As illustrated in FIG. 1A, for example, the interior space of the cylinder tube 32 is partitioned into a first air chamber 42a formed between the piston 38 and the rod cover 36, and a second air chamber 42b formed between the piston 38 and the head cover 34.

The piston rod 40 connected to the piston 38 passes through the first air chamber 42a, and an end part of the piston rod 40 extends to the outside through the rod cover 36. The air cylinder 30 performs tasks such as positioning of workpieces (not illustrated) while pushing out the piston rod 40 (while the piston rod 40 extends), and does not perform any tasks while retracting the piston rod 40.

The first air path 12a is disposed between the first air chamber 42a of the air cylinder 30 and the switching valve 16. The second air path 12b is disposed between the second air chamber 42b of the air cylinder 30 and the switching valve 16.

Two speed control valves (a first speed control valve 50a and a second speed control valve 50b) are disposed on certain points on the second air path 12b. The first speed control valve 50a is an adjustable throttle valve of a so-called meter-out type and allows manual adjustment of the flow rate of air discharged from the second air chamber 42b. On the other hand, the second speed control valve 50b is an adjustable throttle valve of a so-called meter-in type and allows manual adjustment of the flow rate of air supplied to the second air chamber 42b. For the air accumulated in the second air chamber 42b, the ratio of the amount of air supplied to the first air chamber 42a to the amount of air discharged to the outside can be adjusted by operating the first speed control valve 50a.

The first speed control valve 50a includes a first check valve 52a and a first throttle valve 54a connected in parallel. The first check valve 52a allows air to flow toward the second air chamber 42b of the air cylinder 30 via the switching valve 16 and stops air flowing from the second air chamber 42b of the air cylinder 30 toward the switching valve 16. The first throttle valve 54a adjusts the flow rate of air flowing from the second air chamber 42b of the air cylinder 30 toward the switching valve 16.

The second speed control valve 50b includes a second check valve 52b and a second throttle valve 54b connected in parallel. The second check valve 52b allows air to flow from the second air chamber 42b of the air cylinder 30 toward the switching valve 16 and stops air flowing toward the second air chamber 42b of the air cylinder 30 via the switching valve 16. The second throttle valve 54b adjusts the flow rate of air flowing toward the second air chamber 42b of the air cylinder 30 via the switching valve 16.

In the first fluid circuit 10A, a third check valve 52c is connected to a point on the second air path 12b between the air cylinder 30 and the first speed control valve 50a. The third check valve 52c allows air to flow from the second air path 12b toward the switching valve 16 and stops air flowing from the switching valve 16 toward the second air path 12b.

On the other hand, the switching valve 16 is configured as a 5-port, 2-position solenoid valve having a first port 60a to a fifth port 60e and switchable between a first position and a second position. The first port 60a is connected to the first air path 12a. The second port 60b is connected to the second air path 12b. The third port 60c is connected to an air supply source 62. The fourth port 60d is connected to an exhaust port 64 with a silencer 63 attached thereto. The fifth port 60e is connected to the third check valve 52c described above. Moreover, the first port 60a is connected to the fourth port 60d, and the second port 60b is connected to the third port 60c. A third air path 12c extending from the third check valve 52c to the fifth port 60e of the switching valve 16 functions as one air storage.

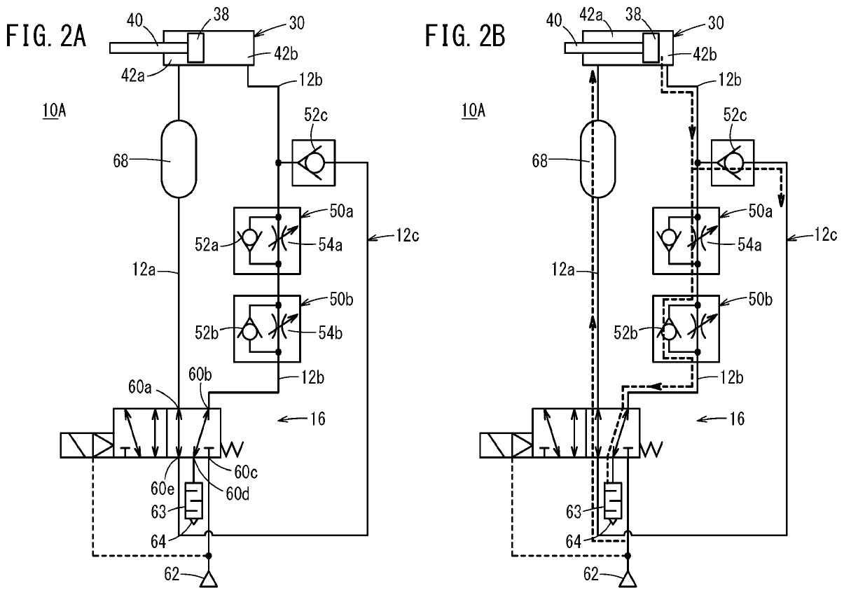

As illustrated in FIG. 1A, when the switching valve 16 is in the first position, the first port 60a is connected to the fourth port 60d, and the second port 60b is connected to the third port 60c. On the other hand, as illustrated in FIG. 2A, when the switching valve 16 is in the second position, the first port 60a is connected to the fifth port 60e, and the second port 60b is connected to the fourth port 60d.

The switching valve 16 is held in the second position by the biasing force of a spring while being de-energized, and switches from the second position to the first position when energized. The switching valve 16 is energized in response to a command to energize (energization) issued to the switching valve 16 by a PLC (Programmable Logic Controller; not illustrated), which is a higher level device, and is de-energized in response to a command to stop energizing (de-energization).

The switching valve 16 is in the first position during the drive process of the air cylinder 30, in which the piston rod 40 is pushed out, and is in the second position during the return process of the air cylinder 30, in which the piston rod 40 is retracted.

A tank portion 68 is disposed on a point on the first air path 12a. The tank portion 68 has a large volume to function as an air tank that accumulates air.

FIGS. 1A to 2B conceptually illustrate the first fluid circuit 10A using circuit diagrams. Some flow paths incorporated in the air cylinder 30 are drawn as if the flow paths were disposed outside the air cylinder 30 for convenience.

In practice, the section enclosed by alternate long and short dash lines in FIG. 1A, that is, part of the second air path 12b including the third check valve 52c and part of the first air path 12a including the tank portion 68 are incorporated in the air cylinder 30.

Moreover, for example, the first air path 12a in the section enclosed by the alternate long and short dash lines in FIG. 1A extends through the rod cover 36, the cylinder tube 32, and the head cover 34 as illustrated in FIG. 3. The part of the section disposed inside the cylinder tube 32 corresponds to the tank portion 68. For example, the cylinder tube 32 may have a double-layered structure including an inner tube and an outer tube so that the space left between the inner and outer tubes serves as the tank portion 68.

The first fluid circuit 10A is basically configured as above. The effects thereof will now be described with reference to FIGS. 1A to 2B. A state where the piston rod 40 is retracted the most while the switching valve 16 is in the first position as illustrated in FIG. 1A is defined as an initial state.

First, as illustrated in FIGS. 1A and 1B, during the drive process, air from the air supply source 62 is supplied to the second air chamber 42b via the second air path 12b in the initial state. This causes air inside the first air chamber 42a to be discharged from the exhaust port 64 to the outside via the first air path 12a. At this moment, air passes through the second speed control valve 50b while the flow rate is adjusted by the second throttle valve 54b, and then is supplied to the second air chamber 42b via the first check valve 52a of the first speed control valve 50a. The air from the air supply source 62 is also supplied from the second air path 12b to the third air path 12c via the third check valve 52c.

This causes the pressure in the second air chamber 42b to start increasing and the pressure in the first air chamber 42a to start dropping. When the pressure in the second air chamber 42b exceeds the pressure in the first air chamber 42a by an amount to overcome static frictional resistance of the piston 38, the piston rod 40 starts moving in a push-out direction. Then, as illustrated in FIG. 1B, the piston rod 40 extends to the maximum position and is held in the position by a large thrust.

After the piston rod 40 extends and a task such as positioning of a workpiece is performed, the switching valve 16 is switched from the first position to the second position as illustrated in FIGS. 2A and 2B. That is, the return process of the piston rod 40 starts.

During the return process, part of the air accumulated in the second air chamber 42b passes through the third check valve 52c and flows toward the first air chamber 42a. At the same time, another part of the air accumulated in the second air chamber 42b is discharged from the exhaust port 64 via the first speed control valve 50a, the second speed control valve 50b, and the switching valve 16. At this moment, air passes through the first speed control valve 50a while the flow rate is adjusted by the first throttle valve 54a, and then flows toward the switching valve 16 via the second check valve 52b of the second speed control valve 50b.

On the other hand, the air supplied toward the first air chamber 42a is accumulated mainly in the tank portion 68. This is because the tank portion 68 occupies the largest space in an area where air can exist between the third check valve 52c and the first air chamber 42a including the first air chamber 42a and the pipes path before retraction of the piston rod 40 starts.

Subsequently, the air pressure in the second air chamber 42b decreases while the air pressure in the first air chamber 42a increases. When the air pressure in the first air chamber 42a becomes higher than the air pressure in the second air chamber 42b by a predetermined amount or more, retraction of the piston rod 40 starts. Then, the first fluid circuit 10A returns to its initial state where the piston rod 40 is retracted the most.

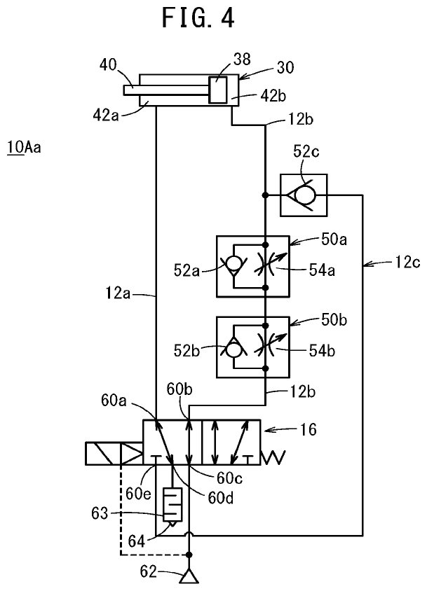

In the example of the first fluid circuit 10A, the tank portion 68 is disposed on the first air path 12a. However, the tank portion 68 may be omitted as in a first fluid circuit 10Aa according to a modification illustrated in FIG. 4 since the inner diameter of the first air path 12a is sufficiently large to function as the tank portion 68.

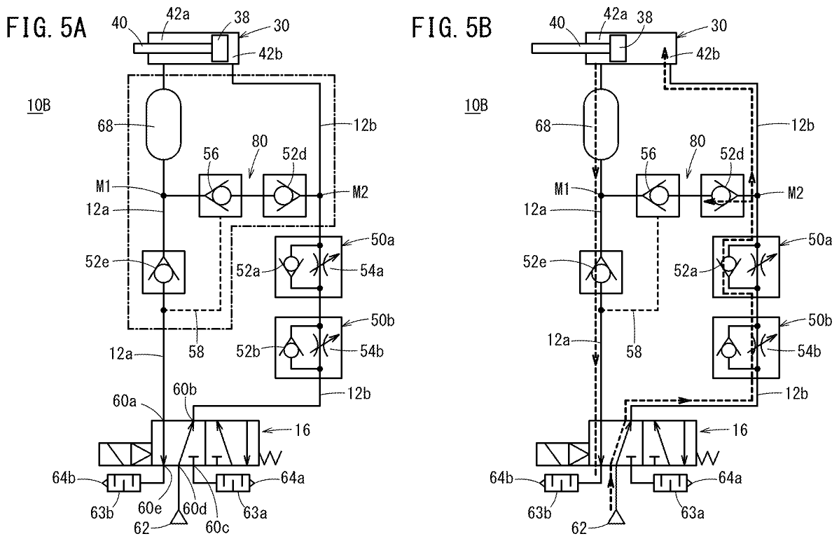

Next, a fluid circuit of an air cylinder according to a second embodiment (hereinafter referred to as “second fluid circuit 10B”) will be described with reference to FIGS. 5A to 7.

The second fluid circuit 10B has a structure almost identical to the structure of the first fluid circuit 10A described above except that the second fluid circuit 10B includes a bypass path 80 instead of the third air path 12c.

That is, in the second fluid circuit 10B, the bypass path 80 branches off from a point on the first air path 12a and joins the second air path 12b at a point on the second air path 12b. That is, the bypass path 80 is disposed between a point M1 on the first air path 12a and a point M2 on the second air path 12b.

The bypass path 80 is provided with a fourth check valve 52d disposed adjacent to the point M2 on the second air path 12b, and a pilot check valve 56 disposed adjacent to the point M1 on the first air path 12a. The fourth check valve 52d allows air to flow from the second air chamber 42b toward the first air chamber 42a and stops air flowing from the first air chamber 42a toward the second air chamber 42b.

The pilot check valve 56 allows air to flow from the first air chamber 42a toward the second air chamber 42b. Moreover, the pilot check valve 56 stops air flowing from the second air chamber 42b toward the first air chamber 42a when not subjected to pilot pressure at a predetermined level or above, and allows air to flow from the second air chamber 42b toward the first air chamber 42a when subjected to pilot pressure at the predetermined level or above. In other words, when not subjected to pilot pressure, the pilot check valve 56 functions as a check valve allowing air to flow from the first air chamber 42a toward the second air chamber 42b and stopping air flowing from the second air chamber 42b toward the first air chamber 42a. When subjected to pilot pressure, the pilot check valve 56 does not function as a check valve and allows air to flow in either direction.

A fifth check valve 52e is disposed on a point on the first air path 12a between the point M1 on the first air path 12a and the switching valve 16. The fifth check valve 52e allows air to flow from the point M1 on the first air path 12a toward the switching valve 16 and stops air flowing from the switching valve 16 toward the point M1 on the first air path 12a. A pilot path 58 branches off from the first air path 12a at a point between the fifth check valve 52e and the switching valve 16 and connects to the pilot check valve 56.

The switching valve 16 in the second fluid circuit 10B is also configured as a 5-port, 2-position solenoid valve having the first port 60a to the fifth port 60e and switchable between the first position and the second position. The first port 60a is connected to the first air path 12a. The second port 60b is connected to the second air path 12b.

The third port 60c is connected to a first exhaust port 64a with a first silencer 63a attached thereto. The fourth port 60d is connected to the air supply source 62. The fifth port 60e is connected to a second exhaust port 64b with a second silencer 63b attached thereto.

The section enclosed by alternate long and short dash lines in FIG. 5A, that is, the tank portion 68, the bypass path 80 including the fourth check valve 52d and the pilot check valve 56, the pilot path 58, part of the first air path 12a including the fifth check valve 52e, and part of the second air path 12b are incorporated in the air cylinder 30.

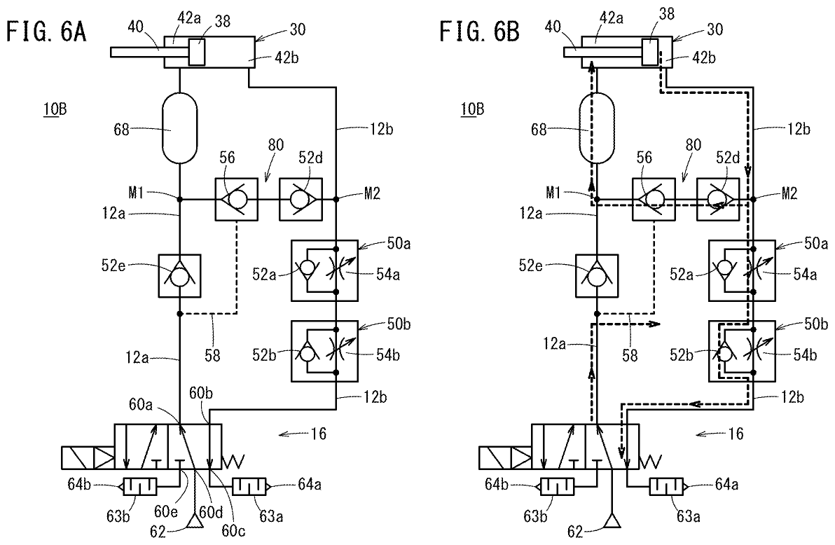

The second fluid circuit 10B is basically configured as above. The effects thereof will now be described with reference to FIGS. 5A to 6B. A state where the piston rod 40 is retracted the most while the switching valve 16 is in the first position as illustrated in FIG. 5A is defined as an initial state.

First, as illustrated in FIGS. 5A and 5B, during the drive process, air from the air supply source 62 is supplied to the second air chamber 42b via the second air path 12b in the initial state. This causes air inside the first air chamber 42a to be discharged from the second exhaust port 64b to the outside via the first air path 12a. At this moment, air passes through the second speed control valve 50b while the flow rate is adjusted by the second throttle valve 54b, and then is supplied to the second air chamber 42b via the first check valve 52a of the first speed control valve 50a.

This causes the pressure in the second air chamber 42b to start increasing and the pressure in the first air chamber 42a to start dropping. When the pressure in the second air chamber 42b exceeds the pressure in the first air chamber 42a by an amount to overcome static frictional resistance of the piston rod 40, the piston rod 40 starts moving in the push-out direction. Then, as illustrated in FIG. 5B, the piston rod 40 extends to the maximum position and is held in the position by a large thrust.

After the piston rod 40 extends and a task such as positioning of a workpiece is performed, the switching valve 16 is switched from the first position to the second position as illustrated in FIG. 6A. That is, the return process of the piston rod 40 starts.

During the return process, air from the air supply source 62 flows into part of the first air path 12a between the fifth check valve 52e and the switching valve 16. The pressure of the air inside the part of the first air path 12a increases as the fifth check valve 52e blocks the air flow. Then, the pressure in the pilot path 58 connected to the first air path 12a becomes higher than or equal to a predetermined level, causing the pilot check valve 56 to stop functioning as a check valve.

When the pilot check valve 56 stops functioning as a check valve, part of the air accumulated in the second air chamber 42b passes through the bypass path 80 including the fourth check valve 52d and the pilot check valve 56 via the point M2 on the second air path 12b, and is supplied from the point M1 on the first air path 12a toward the first air chamber 42a. At the same time, another part of the air accumulated in the second air chamber 42b is discharged from the first exhaust port 64a to the outside via the second air path 12b. At this moment, air passes through the first speed control valve 50a while the flow rate is adjusted by the first throttle valve 54a, and then flows toward the switching valve 16 via the second check valve 52b of the second speed control valve 50b. This causes the pressure in the second air chamber 42b to start dropping and the pressure in the first air chamber 42a to start increasing. At this moment, the air supplied toward the first air chamber 42a is accumulated mainly in the tank portion 68.

The pressure in the second air chamber 42b decreases while the pressure in the first air chamber 42a increases. When the pressure in the second air chamber 42b becomes equal to the pressure in the first air chamber 42a, supply of the air in the second air chamber 42b toward the first air chamber 42a stops due to the effect of the fourth check valve 52d. This causes the pressure in the first air chamber 42a to stop increasing. On the other hand, the pressure in the second air chamber 42b continues to drop. When the pressure in the first air chamber 42a exceeds the pressure in the second air chamber 42b by an amount to overcome the static frictional resistance of the piston 38, the piston rod 40 starts moving in a retraction direction.

When the piston rod 40 starts moving in the retraction direction, the volume of the first air chamber 42a increases, and thus the pressure in the first air chamber 42a drops. However, the rate of the pressure drop is slow as the volume of the first air chamber 42a is substantially increased by the presence of the tank portion 68. As the pressure in the second air chamber 42b drops at a higher rate than the above, the pressure in the first air chamber 42a continues to exceed the pressure in the second air chamber 42b. In addition, the sliding resistance of the piston 38 that has once started moving is less than the frictional resistance of the piston 38 at rest. Thus, the piston rod 40 can move in the retraction direction without any difficulty. In this manner, the second fluid circuit 10B returns to its initial state where the piston rod 40 is retracted the most. The second fluid circuit 10B is maintained in this state until the switching valve 16 is switched again.

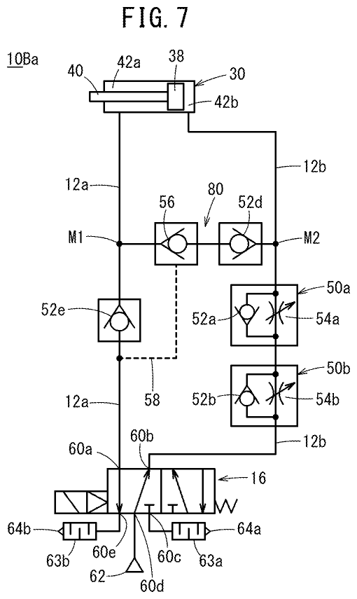

In the example of the second fluid circuit 10B, the tank portion 68 is disposed on the first air path 12a. However, the tank portion 68 may be omitted as in a second fluid circuit 10Ba according to another modification illustrated in FIG. 7 since the inner diameter of part of the first air path 12a between the fifth check valve 52e and the first air chamber 42a is sufficiently large to function as the tank portion 68.

[Invention Derived from Embodiments]

The invention that can be understood from the above-described embodiments will be described below.

The fluid circuit of the air cylinder of the embodiments includes the air cylinder 30 including the first air chamber 42a and the second air chamber 42b partitioned by the piston 38, the switching valve 16 configured to switch between the position for the drive process of the piston 38 and the position for the return process of the piston 38, the first air path 12a disposed between the first air chamber 42a and the switching valve 16, and the second air path 12b disposed between the second air chamber 42b and the switching valve 16. The two speed control valves (the first speed control valve 50a and the second speed control valve 50b) are disposed in series on the second air path 12b.

During the drive process of the piston 38, the supply rate from the switching valve 16 to the second air chamber 42b can be adjusted by the second throttle valve 54b of the second speed control valve 50b. During the return process of the piston 38, the discharge rate from the second air chamber 42b to the switching valve 16 can be adjusted by the first throttle valve 54a of the first speed control valve 50a. That is, the supply rate to the air cylinder 30 and the discharge rate from the air cylinder 30 can be adjusted independently. This leads to a reduction in the stroke time during the drive process and an increase in the pressure inside a fluid pressure cylinder after the return process, which are required characteristics of the fluid circuit. In addition, this can be achieved by simply arranging the two speed control valves in series on the second air path 12b, also leading to simplification of the structure.

In the embodiments, the first check valve 52a of the first speed control valve 50a and the second throttle valve 54b of the second speed control valve 50b constitute the second air path 12b during the drive process, and the first throttle valve 54a of the first speed control valve 50a and the second check valve 52b of the second speed control valve 50b constitute the second air path 12b during the return process.

During the drive process, air supplied to the second air path 12b flows through the first check valve 52a of the first speed control valve 50a and the second throttle valve 54b of the second speed control valve 50b. The air is then supplied to the second air chamber 42b of the air cylinder 30. During the return process, air discharged from the second air chamber 42b of the air cylinder 30 to the second air path 12b flows through the first throttle valve 54a of the first speed control valve 50a and the second check valve 52b of the second speed control valve 50b. The air is then discharged via the switching valve 16. Thus, the supply rate from the switching valve 16 to the second air chamber 42b can be adjusted by the second throttle valve 54b of the second speed control valve 50b during the drive process of the piston 38, and the discharge rate from the second air chamber 42b to the switching valve 16 can be adjusted by the first throttle valve 54a of the first speed control valve 50a during the return process of the piston 38.

In the embodiments, the fluid circuit may include the third air path 12c branching off from the second air path 12b and extending toward the switching valve 16, and the third check valve 52c (external check valve) disposed on the third air path 12c such that the inlet of the third check valve 52c faces the second air path 12b. The third air path 12c may store part of air supplied from the second air path 12b during the drive process and may connect the second air path 12b and the first air path 12a via the switching valve 16 during the return process.

During the drive process, the part of the air supplied from the second air path 12b to the third air path 12c is stored in the third air path 12c. During the subsequent return process, the air stored in the third air path 12c is supplied to the first air chamber 42a of the air cylinder 30 via the switching valve 16 and the first air path 12a. That is, the air stored in the third air path 12c can be used as the pressure to return the piston 38, leading to a reduction in the air consumption.

In the embodiments, the fluid circuit may include the bypass path 80 disposed between the first air path 12a and the second air path 12b, and the fourth check valve 52d (internal check valve) and the pilot check valve 56 (internal pilot check valve) disposed on the bypass path 80. The fourth check valve 52d may allow air to flow from the second air chamber 42b toward the first air chamber 42a and stop air flowing from the first air chamber 42a toward the second air chamber 42b. The pilot check valve 56 may allow air to flow from the first air chamber 42a toward the second air chamber 42b and stop air flowing from the second air chamber 42b toward the first air chamber 42a when the pilot check valve 56 is not subjected to pilot pressure.

This enables the air accumulated in the second air chamber 42b to be supplied toward the first air chamber 42a and, at the same time, to be discharged to the outside. As the pressure in the first air chamber 42a increases while the pressure in the second air chamber 42b decreases quickly, the time required to return the air cylinder 30 can be reduced as much as possible. Moreover, since no collection valve with a complex structure is required, the fluid circuit to return the air cylinder 30 can be simplified.

In the embodiments, the tank portion 68 may be disposed on the first air path 12a adjacent to the first air chamber 42a. This enables air discharged from the second air chamber 42b to be accumulated in the tank portion 68 and prevents the pressure in the first air chamber 42a from decreasing as much as possible when the volume of the first air chamber 42a increases during the return process of the air cylinder 30.

The fluid circuit of the air cylinder according to the present invention is not limited in particular to the embodiments described above, and may have various structures without departing from the scope of the present invention as a matter of course.

1. A fluid circuit of an air cylinder, comprising:
an air cylinder including a first air chamber and a second air chamber partitioned by a piston;
a switching valve configured to switch between a position for a drive process of the piston and a position for a return process of the piston;
a first flow path disposed between the first air chamber and the switching valve; and
a second flow path disposed between the second air chamber and the switching valve, wherein
two speed control valves are disposed in series on the second flow path.

2. The fluid circuit of the air cylinder according to claim 1, wherein
during the drive process, a check valve of one speed control valve of the two speed control valves and an adjustable throttle valve of another speed control valve constitute the second flow path; and
during the return process, an adjustable throttle valve of the one speed control valve and a check valve of the another speed control valve constitute the second flow path.

3. The fluid circuit of the air cylinder according to claim 1, further comprising:
a third flow path branching off from the second flow path and extending toward the switching valve; and
an external check valve disposed on the third flow path, an inlet of the external check valve facing the second flow path, wherein:
during the drive process, the third flow path stores part of air supplied from the second flow path; and
during the return process, the third flow path connects the second flow path and the first flow path via the switching valve.

4. The fluid circuit of the air cylinder according to claim 1, further comprising:
a bypass path disposed between the first flow path and the second flow path; and
an internal check valve and an internal pilot check valve disposed on the bypass path, wherein:
the internal check valve allows air to flow from the second air chamber toward the first air chamber and stops air flowing from the first air chamber toward the second air chamber, while the internal pilot check valve allows air to flow from the first air chamber toward the second air chamber and stops air flowing from the second air chamber toward the first air chamber when the internal pilot check valve is not subjected to pilot pressure.

5. The fluid circuit of the air cylinder according to claim 1, wherein a tank portion is disposed on the first flow path adjacent to the first air chamber.
